(19) United States
(12) Patent Application Publication
(10) Pub. No.: US 2007/0217083 A1
(43) Pub. Date: Sep. 20, 2007

(54) Magnetoresistive effect device and method of manufacturing ferromagnetic structure

(75) Inventors: Keiichi Nagasaka, Kawasaki (JP); Hirotaka Oshima, Kawasaki (JP); Arata Jogo, Kawasaki (JP); Yutaka Shimizu, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/483,565

(22) Filed: Jul. 11, 2006

(30) Foreign Application Priority Data
Mar. 15, 2006 (JP) 2006-071035

(51) Int. Cl. G11B 5/33

(52) U.S. Cl. 360/324.11

(57) ABSTRACT

A spin valve film has a lamination structure of a pinned layer, a non-magnetic intermediate layer and a free layer. The pinned layer is made of ferromagnetic material and has a fixed magnetization direction. The non-magnetic intermediate layer is made of non-magnetic conductive material. The free layer is made of ferromagnetic material and changes a magnetization direction by external magnetic field. Electrodes let current flow through the spin valve film in a lamination direction. At least one of the pinned layer and the free layer includes a lamination portion of a first layer and a second layer stacked alternately. The first layer has a composition ratio of elements presenting ferromagnetism higher than that in the second layer. The second layer has a composition ratio of elements presenting non-magnetism higher than that in the first layer. The lamination portion includes at least two first layers and at least one second layer.

### CROSS REFERENCE TO RELATED APPLICATION

This application is based on and claims priority of Japanese Patent Application No. 2006-071035 filed on Mar. 15, 2006, the entire contents of which are incorporated herein by reference.

### BACKGROUND OF THE INVENTION

A) Field of the Invention

The present invention relates to a method of manufacturing a magnetoresistive effect device and a ferromagnetic structure, and more particularly to a method of manufacturing a magnetoresistive effect device whose sense current flows through a spin valve film in its thickness direction and a ferromagnetic structure suitable for a free layer of the spin valve film.

B) Description of the Related Art

A magnetoresistive effect device using a spin valve film has a ferromagnetic pinned layer having a fixed magnetization direction, a ferromagnetic free layer whose magnetization direction changes freely with an external magnetic field, and a non-magnetic intermediate layer sandwiched between the pinned layer and the free layer. In a conventional magnetoresistive effect device, a sense current is flowed in an in-plane direction of the spin valve film to detect a resistance change. This device structure is called a current in plane (CIP) structure.

As a higher sensitivity magnetoresistive effect device, a magnetoresistive effect device of a current perpendicular to plane (CPP) structure has been drawn attention in which a resistance change is detected by letting a sense current flow through a spin valve film in its thickness direction. A magnetoresistive effect device of the CPP structure is characterized in that as the size is made smaller, an output increases. This device is promising as a high sensitivity reproducing head of a high density magnetic recording apparatus. Magnetoresistive effect devices of the CPP structure are disclosed in JP-A-2003-218428 and JP-2003-152239.

In a magnetoresistive effect device of the CIP structure, the main factor of a resistance change is a spin dependent interface scattering resistance at the interface between the magnetic layer and non-magnetic layer. In a magnetoresistive effect device of the CPP structure, the main factor of a resistance change is a spin dependent bulk scattering resistance as well as the spin dependent interface scattering resistance. It is therefore possible to ensure a high magnetoresistance change by using magnetic material having a large spin dependent bulk scattering resistance as the material of the pinned layer and free layer and by making these layers thicker.

Magnetic material having a large spin dependent bulk scattering resistance is, for example, CoFe in which a composition ratio of Fe is 25 atom % or higher. It has been confirmed that the performance of a giant magnetoresistive (GMR) effect of the CPP structure can be improved by using CoFe in which a composition ratio of Fe is 25 atom % or higher.

### SUMMARY OF THE INVENTION

CoFe in which a composition ratio of Fe is 22 atom % or higher has a body centered cubic (bcc) lattice structure and presents hard magnetism. Therefore, it is not preferable from the viewpoint of high sensitivity device to use CoFe in which a composition ratio of is 22 atom % or higher, as the material of the free layer of a spin valve film which is required to have a low coercive force. It is preferable to use magnetic films having a lowered coercive force for a magnetoresistive effect device of the CPP structure, while the spin dependent bulk scattering resistance is maintained high.

An object of the present invention is to provide a magnetoresistive effect device having magnetic films having a lowered coercive force while the spin dependent bulk scattering resistance is maintained high. Another object of the present invention is to provide a method of manufacturing a ferromagnetic structure suitable for manufacturing the magnetic films.

According to one aspect of the present invention, there is provided a magnetoresistive effect device comprising:

a spin valve film having a lamination structure of a first pinned layer made of ferromagnetic material and having a fixed magnetization direction, a non-magnetic intermediate layer made of non-magnetic conductive material and a free layer made of ferromagnetic material and changing a magnetization direction under influence of an external magnetic field, stacked in this order; and

a pair of electrodes for letting current flow through the spin valve film in a lamination direction,

wherein at least one of the first pinned layer and the free layer includes a lamination portion of a first layer and a second layer stacked alternately, the first layer having a composition ratio of elements presenting ferromagnetism higher than that in the second layer and the second layer having a composition ratio of elements presenting non-magnetism higher than that in the first layer, and the lamination portion includes at least two first layers and at least one second layer.

According to another aspect of the present invention, there is provided a method of manufacturing a ferromagnetic structure, comprising steps of:

(a) alternately depositing a first layer made of ferromagnetic material and a second layer made of non-magnetic conductive material over a substrate, to deposit at least two first layers and at least one second layer; and

(b) performing heat treatment under a condition that although mutual diffusion occurs at an interface between the first layer and the second layer, a periodical structure made of the first layer and the second layer will not extinguish;

wherein the step (a) deposits the first layer and the second layer under a condition that the second layer degrades crystallinity of the first layer more than a single layer structure that only the first layer is grown without sandwiching the second layer.

Since the free layer is formed having the lamination structure of the first and second layers, a coercive force can be made smaller as compared to a single layer structure having the same composition as that of the first layer. Since the first pinned layer or free layer is formed having the lamination structure of the first and second layers, amount of change in resistance of the spin valve film can be made large.

### BRIEF DESCRIPTION OF THE DRAWINGS

FIG. 1A is a front view of a magnetoresistive effect device according to a first embodiment, FIG. 1B is a front view of a first pinned layer of the magnetoresistive effect device, and FIG. 1C is a front view of a free layer of the magnetoresistive effect device.

FIG. 2 is a graph showing a coercive force of a free layer and amount of change in resistance of the magnetoresistive effect device of the first embodiment and the magnetoresistive effect device of a comparative example.

FIG. 3 is a graph showing a relation between a heat treatment temperature and amount of change in resistance of a spin valve film of the magnetoresistive effect device of the first embodiment.

FIG. 4 is a front view of a magnetoresistive effect device according to a second embodiment.

FIG. 5A is a perspective view of a magnetic head in which the magnetoresistive effect device of the first or second embodiment is adopted, and FIG. 5B is a plan view of a magnetic recording apparatus.

FIG. 6 is a cross sectional view of an MRAM according to a third embodiment.

### DESCRIPTION OF THE PREFERRED EMBODIMENTS

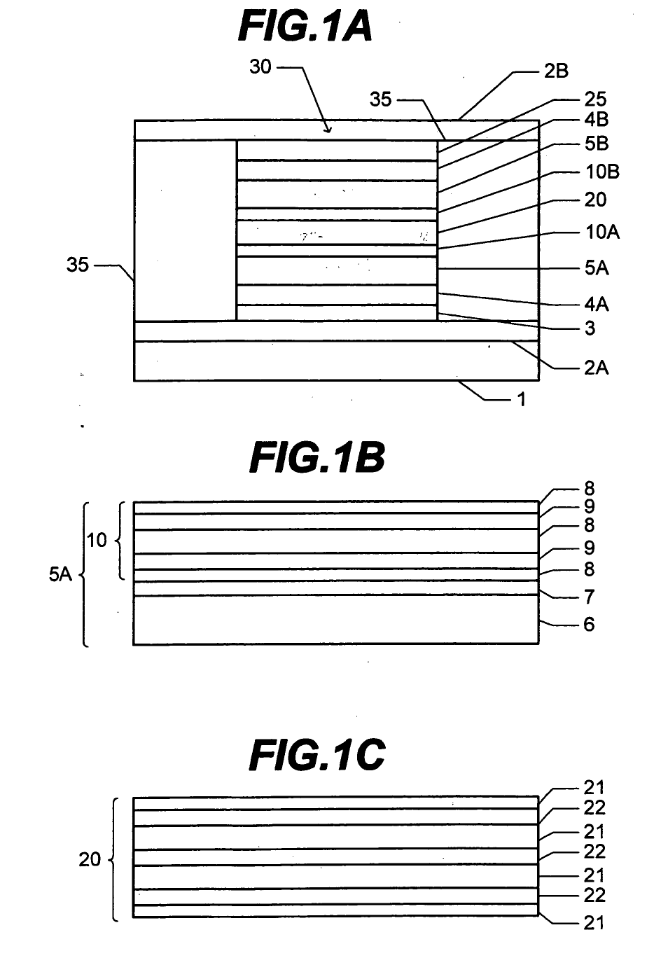

FIG. 1A is a front view of a magnetoresistive effect device according to the first embodiment. When the magnetoresistive effect device is to be applied to a reproducing head of a hard disk drive, a magnetic recording medium is positioned facing the drawing sheet.

On a substrate 1 made of AlTiC, a first magnetic shielding layer 2A made of ferromagnetic material such as NiFe is formed. A spin valve film 30 is formed on a partial region of the first magnetic shielding layer 2A.

The spin valve film 30 has a lamination structure of an underlying layer 3, a first pinning layer 4A, a first pinned layer 5A, a first non-magnetic intermediate layer 10A, a free layer 20, a second non-magnetic intermediate layer 10B, a second pinned layer 5B, a second pinning layer 4B and a cap layer 25, stacked in this order. For example, the underlying layer 3 is made of NiCr and has a thickness of 4 nm. Each of the first and second pinning layers 4A and 4B is made of antiferromagnetic material such as IrMn and has a thickness of 5 nm. Each of the first and second non-magnetic intermediate layers 10A and 10B is made of nonmagnetic conductive material such as Cu and has a thickness of 3.5 nm. The cap layer 25 is made of, for example, Ru and has a thickness of 5 nm.

FIG. 1B is a front view of the first pinned layer 5A. The first pinned layer 5A has a ferromagnetic pinned layer 6, a non-magnetic intermediate layer 7 and a reference layer 10, stacked in this order from the first pinning layer 4A side. The ferromagnetic pinned layer 6 is made of CoFe and has a thickness of 2.5 nm. The non-magnetic intermediate layer 7 is made of, for example, Ru and has a thickness of 0.7 nm. The reference layer 10 has a lamination structure of first layers 8 of Co₇₀Fe₃₀ and second layers 9 of Al alternately stacked, and includes three first layers 8 and two second layers 9. A thickness of each of the outermost first layers 8 is 0.6 nm, and a thickness of the middle first layer 8 is 1.2 nm. Each of the second layers 9 has a thickness of 0.8 nm.

The magnetization direction in the pinned layer 6 is fixed because of magnetic exchange coupling between the ferromagnetic pinned layer 6 and the first pinning layer 4A. The magnetization direction in the first layers 8 is fixed antiparallel to the magnetization direction of the ferromagnetic pinned layer 6 because of antiferromagnetic exchange coupling between the first layers 8 constituting the reference layer 10 and the ferromagnetic pinned layer 6 through the non-magnetic intermediate layer 7.

The second pinned layer 5B has the same lamination structure as that of the first pinned layer 5A, and is plane-symmetrical to the first pinned layer 5A relative to the free layer 20.

FIG. 1C is a front view of the free layer 20. The free layer 20 has a lamination structure of first layers 21 of Co₇₀Fe₃₀ and second layers 22 of Al alternately stacked, and includes four first layers 21 and three second layers 22. A thickness of each of the outermost first layers 21 is 0.6 nm, and a thickness of each of the other first layers 21 is 1.2 nm. Each of the second layers 22 has a thickness of 0.8 nm. A magnetization direction of the first layer 21 changes freely being influenced by an external magnetic field.

Description will be made by reverting to FIG. 1A. An insulating layer 35 is disposed on the first magnetic shielding layer 2A on both sides of the spin valve film 30. The upper surface of the insulating layer 35 is approximately located at the same level as the upper surface of the spin valve film 30. A second magnetic shielding layer 2B made of ferromagnetic material such as NiFe is formed on the spin valve film 30 and insulating layers 35.

The first and second magnetic shielding layers 2A and 2B suppress that a magnetic field from a surface region of a magnetic recording medium other than the surface region facing the spin valve film 30 enters the inside of the spin valve film 30. The first and second magnetic shielding layers 2A and 2B also serve as electrodes for letting a sense current flow through the spin valve film 30 in a thickness direction.

Next, description will be made on a method of manufacturing the magnetoresistive effect device of the first embodiment. The first and second magnetic shielding layers 2A and 2B and each layer of the spin valve film 30 are formed by DC magnetron sputtering. The spin valve film 30 is formed by depositing each layer and thereafter patterning the layers by photolithography and ion milling. A junction area of the spin valve film 30 is, for example, set in a range between 0.1 μm² and 1 μm².

After the spin valve film 30 is formed, heat treatment is performed at a temperature of 300° C. in magnetic field applied vacuum, to thereby reinforce a magnetization fixing force of the first and second pinned layers 5A and 5B by the first and second pinning layers 4A and 4B. During heat treatment, mutual diffusion occurs at the interface between the first and second layers 8 and 9 constituting the reference layer 10 and at the interface between the first and second layers 20 and 21 constituting the free layer 20, so that CoFeAl alloy is formed at the interfaces. However, the periodical structure of the reference layer 10 constituted of the first and second layers 8 and 9 and the periodical structure of the free layer 20 constituted of the first and second layers 20 and 21, will not extinguish. It is therefore possible even after the heat treatment to maintain the condition that a composition ratios of Co and Fe in the first layers 8 and 21 are higher than those of the second layers 9 and 22 and that a composition ratio of Al in the second layers 9 and 22 is higher than that of the first layers 8 and 21.

For the purposes of comparison, a sample was prepared in which each of the first pinned layer 5A, the second pinned layer 5B and free layer 20 of the magnetoresistive effect device of the first embodiment was replaced by a single layer made of Co₇₀Fe₃₀. A thickness of each of the first and second pinned layers of the comparative example is equal to a total thickness of the first layers 8 constituting the first and second pinned layers 5A and 5B of the magnetoresistive effect device of the first embodiment. A thickness of the free layer of the comparative example is equal to a total thickness of the first layers 21 constituting the free layer 20 of the first embodiment.

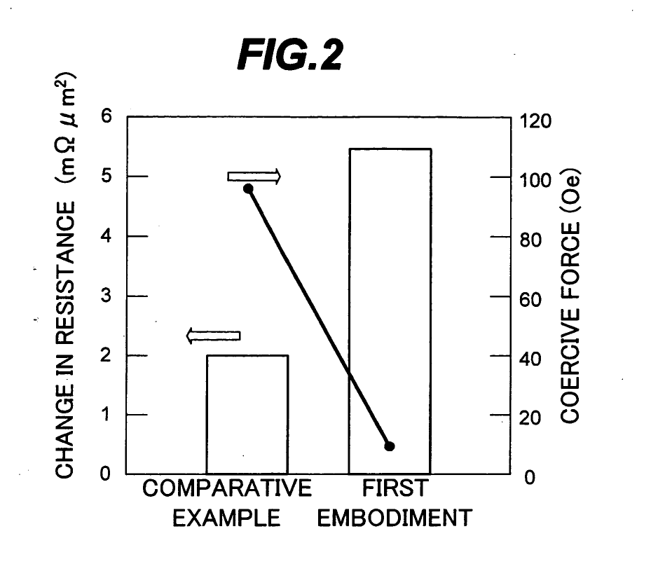

FIG. 2 shows the measurement results by a four-probe method of a coercive force of the free layer and an amount of change in resistance of the magnetoresistive effect device of the first embodiment and the sample of the comparative example. A left ordinate represents an amount of change in resistance in the unit of “mΩμm²” and a right ordinate represents a coercive force in the unit of “Oe”. The measurements were conducted by applying a magnetic field of ±1000 Oe at a room temperature.

It can be seen that a coercive force of the free layer 20 of the magnetoresistive effect device of the first embodiment is one fifth of the coercive force of the free layer of the comparative example. It can also be seen that an amount of change in resistance of the magnetoresistive effect device of the first embodiment is more than double that of the comparative example. It can be understood that the performance of the magnetoresistive effect device can be improved by forming the free layer 20 as an alternative lamination structure of first layers 21 of CoFe and second layers 22 of Al, and by forming the reference layer 10 as an alternative lamination structure of first layers 8 of CoFe and second layers 9 of Al.

The reason for this will be described. It can be considered that CoFe of the first and second pinned layers and free layer of the comparative example has the bcc lattice structure. A coercive force is therefore larger than those of the corresponding layers of the first embodiment. In the first embodiment, the second layers 9 and 22 of Al are inserted, so that growth of the first layers 8 and 21 of CoFe is decoupled. It can therefore be considered that large crystal grains having a high quality bcc lattice structure are hard to be formed and crystallinity of the first layers 8 and 21 is degraded as a whole. It can be considered that the coercive force lowers because of degraded crystallinity.

Further, in the first embodiment, a resistivity at the interface between the first layer 8 and second layer 9 constituting the first and second pinned layers 5A and 5B and at the interface between the first layer 21 and second layer 22 constituting the free layer 20 increases the total resistivity of the spin valve film 30. It can be considered that the amount of change in resistance increases because the resistivity of the spin valve film 30 increases.

In the first embodiment, although both the first and second pinned layers 5A and 5B and the free layer 20 have the alternate lamination structure of first and second layers, one may have the alternate lamination structure and the other may be a single layer of CoFe. As the free layer 20 is formed having the alternate lamination structure, in addition to the advantage of an increased amount of change in resistance, an advantage of a lowered coercive force of the free layer 20 can be obtained.

In the first embodiment, although the first layers 8 and 21 are made of Co₇₀Fe₃₀ and the second layers 9 and 21 are made of Al, the first layers 8 and 21 may be made of other ferromagnetic materials and the second layers 9 and 22 may be made of other non-magnetic conductive materials. If the first layers 8 and 21 are to be made of CoFe, it is preferable that a composition ratio of Fe is set to 22 atom % or higher. As the composition ratio of Fe is set to 22 atom % or higher, CoFe has the bcc lattice structure. However, as in the first embodiment, the first layers 8 and 21 of CoFe can be suppressed from having a high quality bcc lattice structure, so that a remarkable advantage of a lowered coercive force of the free layer 20 can be obtained.

Next, description will be made on appropriate thicknesses of the first layers 8 and 21 and second layers 9 and 22. At an initial growth stage of the first layer 8, a number of fine crystal grains are generated, and as the growth progresses, dominant large crystal grains grow and the crystallinity quality becomes high. The crystallinity quality can be evaluated by various evaluation methods such as X-ray rocking curve and Raman scattering. As the first layers 8 and 21 are grown in excess of a certain thickness, the crystallinity quality becomes generally constant. As a high quality film having a constant crystallinity quality starts growing, the effect of decoupling the growth of the first layers 8 and 21 by the second layers 9 and 22 is degraded. It is preferable that a thickness of each of the first layers 8 and 21 is set thinner than the thickness at which the crystallinity quality becomes constant. For example, it is preferable to set the thickness of each of the first layers 8 and 21 to 2 nm or thinner. The thickness is preferably set to 0.1 nm or thicker in order to make the first layers 8 and 21 present sufficient ferromagnetism. It is sufficient that the second layers 9 and 22 have a thickness sufficient for decoupling the growth of the first layers 8 and 21. A preferable range of a thickness of each of the second layers 9 and 22 is from 0.2 nm to 2 nm. The second layers 9 and 22 are not required to cover the whole surface, but the second layers may have a structure that small regions exist in a dispersed manner, or a void structure that openings are left partially.

Non-magnetic material of the second layers 9 and 22 is preferably such material as even if the material forms alloy of the ferromagnetic material of the first layers 8 and 21, a coercive force of the alloy is smaller than that of the original ferromagnetic material. Such materials may be Cr, Si, Ge and the like, in addition to Al.

It is necessary that at least two layers of each of the first layers 8 and 21 are formed. Each of the second layers 9 and 22 may be one layer. Namely, the minimum structure of each of the free layer 20 and reference layer 10 is a three-layer structure of the first layer, second layer and first layer stacked in this order.

Next, description will be made on an appropriate range of a temperature of heat treatment after the spin valve film 30 is formed.

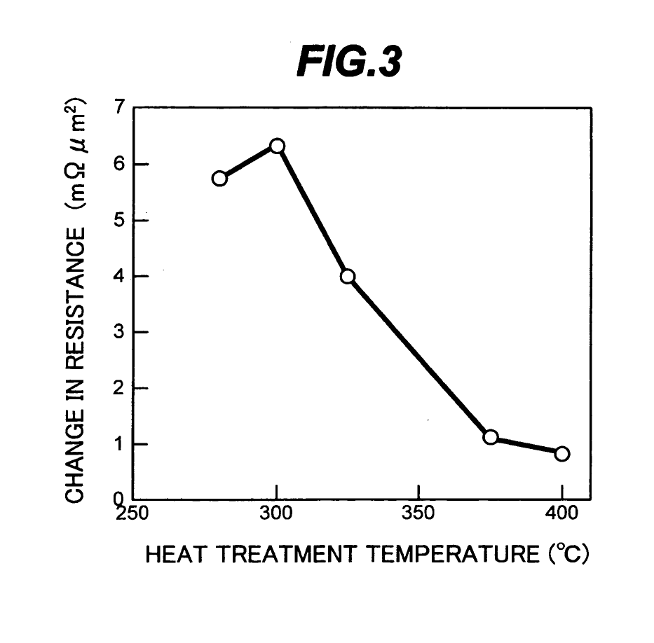

FIG. 3 shows a relation between a heat treatment temperature and a resistance change amount. An abscissa represents a heat treatment temperature in the unit of “° C.” and the ordinate represents a resistance change amount in the unit of “mΩμm²”. The largest resistance change amount is obtained at a heat treatment temperature of 300° C. It can be considered in this case that the degree of mutual diffusion is appropriate at the interface between the first layer 8 and second layer 9 and at the interface between the first layer 21 and second layer 22. If the heat treatment temperature is raised in a range higher than 300° C., the resistance change amount lowers abruptly. In order to retain a large resistance change amount, it is preferable to set the heat treatment temperature to 325° C. or lower. It can be understood that at a heat treatment temperature of 280° C., an amount of change in resistance is approximately equal to that at the heat treatment temperature of 300° C.

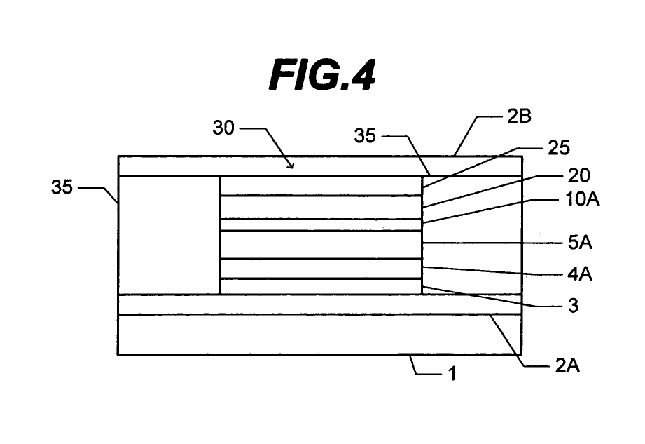

FIG. 4 is a front view of a magnetoresistive effect device according to the second embodiment. The spin valve film 30 of the first embodiment is a so-called dual type in which the lamination structure from the first non-magnetic intermediate layer 10A to first pinning layer 4A is plane-symmetric with the lamination structure from the second non-magnetic intermediate layer 10B to second pinning layer 4B with reference to the free layer 30. The spin valve film 30 of the second embodiment is a single type. Description will be made by paying attention to different points from the magnetoresistive effect device of the first embodiment, and description of the same structure is omitted.

The lamination structure from an underlying layer 3 to a free layer 20 shown in FIG. 4 is the same as the lamination structure from the underlying layer 3 to free layer 20 of the magnetoresistive effect device of the first embodiment shown in FIG. 1A. In the second embodiment, the lamination structure from the second non-magnetic intermediate layer 10B to second pinning layer 4B shown in FIG. 1A is not disposed, but the cap layer 25 is disposed directly on the free layer 20.

As in the case of the first embodiment, also in the second embodiment, a coercive force of the free layer 20 can be lowered and an amount of change in resistance can be made large.

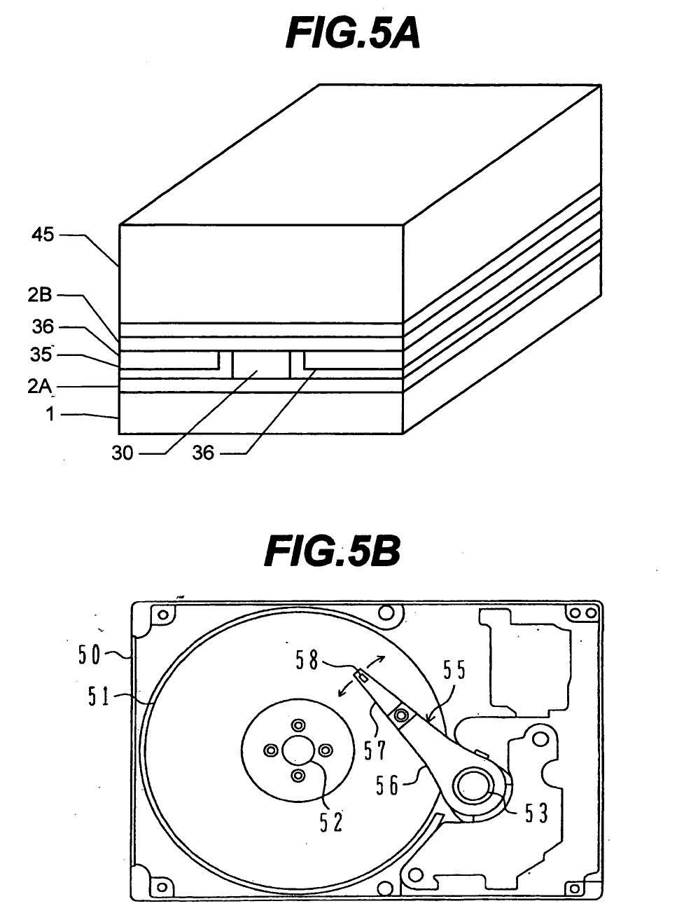

FIG. 5A is a perspective view of a magnetic head using the magnetoresistive effect device of the first or second embodiment. On a substrate 1 of AlTiC or the like, the first magnetic shielding layer 2A is formed, and the spin valve film 30 is formed on a partial surface region of the first magnetic shielding layer 2A. The spin valve film 30 has the same structure as that of the spin valve film 30 of the magnetoresistive effect device of the first or second embodiment. The insulating layer 35 is disposed on both sides of the spin valve film 30. A hard ferromagnetic layer 36 is embedded in the upper portion in each of the insulating layers 35. The hard ferromagnetic layer 36 imparts initial magnetization in the free layer 20 of the spin valve film 30, in a direction perpendicular to the magnetization direction of the first and second pinned layers 5A and 5B. It is therefore possible to improve a linear response performance of the amount of change in resistance.

The second magnetic shielding layer 2B is formed on the spin valve film 30, insulating layers 35 and hard ferromagnetic layers 36. A write magnetic head portion 45 is disposed on the second magnetic shielding layer 2B.

FIG. 5B is a plan view of a magnetic recording apparatus using the magnetoresistive effect device of the first or second embodiment. A housing 50 defines an internal space of a flat rectangular solid shape. At least one magnetic disk 51 is accommodated in the internal space. The magnetic disk 51 is mounted on a rotary shaft of a spindle motor 52. The spindle motor 52 rotates the magnetic disk 51 at high speed, e.g., at 7200 rpm or 10000 rpm.

A head actuator 55 is mounted on a support shaft 53 extending in a direction parallel to the rotary shaft of the spindle motor 52. The head actuator 55 is equipped with an arm 56 and a suspension 57. The arm 56 is supported pivotally by the support shaft 53 in a direction parallel to the plane of the magnetic disk 51. The suspension 57 is mounted at the distal end of the arm 56 and extends along the extension line of the arm 56. A floating head slider 58 is mounted at the distal end of the suspension 57. The magnetic head shown in FIG. 5A is mounted on the floating head slider 58.

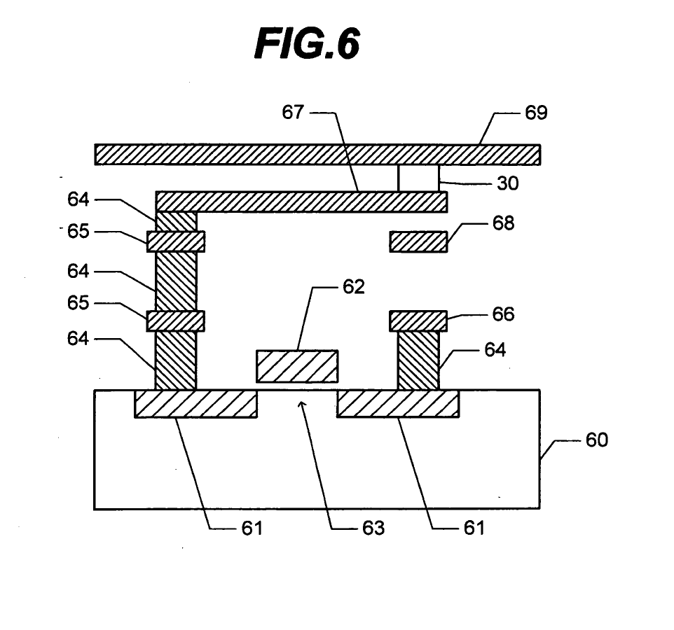

FIG. 6 is a cross sectional view of a magnetic random access memory (MRAM) according to the third embodiment. A read word line 62, a MOS transistor 63, a write word line 68, a bit line 69 and a spin valve film 30 are disposed on a silicon substrate 60. The read word line 62 and write word line 68 are in one-to-one correspondence with each other, and extend in a first direction (direction perpendicular to the drawing sheet of FIG. 6). The bit line 69 extends in a second direction crossing the first direction (lateral direction in FIG. 6).

The MOS transistor 63 is disposed at a cross point between the read word line 62 and bit line 69. The read word line 62 serves also as the gate electrode of the MOS transistor 63. Namely, a conductive state of the MOS transistor 63 is controlled by a voltage applied to the read word line 62.

The spin valve film 30 is disposed at a cross point between the write word line 68 and bit line 69, and has the same structure as that of the spin valve film 30 of the magnetoresistive effect device of the first or second embodiment. A magnetization direction of the free layer of the spin valve film 30 changes under the influence of a magnetic field generated by letting current flow through the write word line 68. The underlying layer 3 (refer to FIGS. 1A and 4) of the spin valve film 30 is connected to one of impurity doped regions 61 of the MOS transistor 63 via a wiring 67, a plurality of plugs 64 formed through a multilayer wiring layer and isolated wirings 65. The cap layer 25 (refer to FIGS. 1A and 4) of the spin valve film 30 is connected to the bit line 69. Namely, the wiring 67 and bit line 69 are used as electrodes for letting a sense current flow through the spin valve film 30 in its thickness direction.

The other impurity doped region 61 of the MOS transistor 63 is connected to a wiring 66 via the plug 64.

The spin valve film 30 is formed having the same structure as that of the spin valve film 30 of the first or second embodiment, so that a coercive force of the free layer can be lowered and the amount of change in current can be made large. It is therefore possible to reduce the current to be flowed through the write word line 68 for data write. It is also possible to retain a large margin when stored data is read.

The present invention has been described in connection with the preferred embodiments. The invention is not limited only to the above embodiments. It will be apparent to those skilled in the art that other various modifications, improvements, combinations, and the like can be made.

What we claim are:

1. A magnetoresistive effect device comprising:
a spin valve film having a lamination structure of a first pinned layer made of ferromagnetic material and having a fixed magnetization direction, a non-magnetic intermediate layer made of non-magnetic conductive material and a free layer made of ferromagnetic material and changing a magnetization direction under influence of an external magnetic field, stacked in this order; and
a pair of electrodes for letting current flow through the spin valve film in a lamination direction,
wherein at least one of the first pinned layer and the free layer includes a lamination portion of a first layer and a second layer stacked alternately, the first layer having a composition ratio of elements presenting ferromagnetism higher than that in the second layer and the second layer having a composition ratio of elements presenting non-magnetism higher than that in the first layer, and the lamination portion includes at least two first layers and at least one second layer.

2. The magnetoresistive effect device according to claim 1, wherein the elements presenting the non-magnetism contained in the second layer is at least one of elements selected from a group consisting of Al, Cr, Si and Ge.

3. The magnetoresistive effect device according to claim 1, wherein the elements presenting the ferromagnetism in the first layer comprises Co and Fe.

4. The magnetoresistive effect device according to claim 3, wherein a content of Fe in the first layer is 22 atom % or higher.

5. The magnetoresistive effect device according to claim 1, wherein the pair of electrodes is made of ferromagnetic material and serves also as magnetic shielding films disposed sandwiching the spin valve film.

6. The magnetoresistive effect device according to claim 1, wherein the spin valve film further includes a second non-magnetic intermediate layer and a second pinned layer, the first non-magnetic intermediate layer and the second non-magnetic intermediate layer sandwich the free layer, and the second pinned layer and the free layer sandwich the second non-magnetic intermediate layer.

7. The magnetoresistive effect device according to claim 1, further comprising:
a read word line disposed over a substrate and extending in a first direction;
a write word line disposed over the substrate in correspondence with the read word line and extending in the first direction;
a bit line disposed over the substrate and extending in a second direction crossing the first direction; and
a transistor disposed at a cross point between the read word line and the bit line, a conductive state of the transistor being controlled by voltage applied to a corresponding read word line,
wherein the spin valve film is disposed at a cross point between the write word line and the bit line, the magnetization direction of the free layer of the spin valve film changes under influence of a magnetic field generated by letting current flow through the write word line, one of the pair of electrodes is connected to the transistor, and the other electrode is connected to the bit line or serves as the bit line.

8. A method of manufacturing a ferromagnetic structure, comprising steps of:
(a) alternately depositing a first layer made of ferromagnetic material and a second layer made of non-magnetic conductive material over a substrate, to deposit at least two first layers and at least one second layer; and
(b) performing heat treatment under a condition that although mutual diffusion occurs at an interface between the first layer and the second layer, a periodical structure made of the first layer and the second layer will not extinguish;
wherein the step (a) deposits the first layer and the second layer under a condition that the second layer degrades crystallinity of the first layer more than a single layer structure that only the first layer is grown without sandwiching the second layer.

9. The method of manufacturing the ferromagnetic structure according to claim 8, wherein the first layer comprises Co and Fe and the second layer comprises at least one element selected from a group of Al, Cr, Si and Ge.

10. The method of manufacturing the ferromagnetic structure according to claim 9, wherein the heat treatment is performed in a range from 280° C. to 325° C.
